(19) United States
(12) Patent Application Publication
(10) Pub. No.: US 2025/0001645 A1
(43) Pub. Date: Jan. 2, 2025

(54) MDI included Net Zero Green Energy Pallet Composition

(71) Applicants: SHIAO-YUNG LIAO, TAIPEI (TW); JIAN-SIAN WU, TAIPEI (TW)

(72) Inventors: SHIAO-YUNG LIAO, TAIPEI (TW); JIAN-SIAN WU, TAIPEI (TW)

(21) Appl. No.: 18/663,087

(22) Filed: May 14, 2024

(30) Foreign Application Priority Data
Jun. 29, 2023 (TW) TW112206762

(51) Int. Cl. B27N 5/00; B27N 1/02

(52) U.S. Cl. CPC B27N 5/00; B27N 1/0209

(57) ABSTRACT

The “MDI included Net Zero Green Energy Pallet Composition”, wherein the “MDI included Net Zero Green Energy Pallet” is composed of recycled wood, processing residual wood, sawdust, straw, etc., which are processed by machines, crushed and dried, and the wood chips are mixed with methylene diphenyl diisocyanate (MDI) component glue, made by hot-pressing molded. Among them, the “MDI included Net Zero Green Energy Pallet” has a primarily 2×2 grid look, consisting of a pallet body, numerous support legs, and multiple reinforcing ribs, combined with conveyor belt components or double-sided pallet type. When there are nine support legs, the outside of the legs are trapezoidal and the inside is concave downward, which includes the left, center, and right support legs. The reinforcing ribs are hot-pressed and molded into grooves on the pallet's surface, and they include connecting and arc-shaped reinforcing ribs, as well as central connecting and reinforcing ribs.

### PRIOR ART

This invention pertains to the technological field of pallet manufacture, specifically pallets that are mechanically pressed utilizing a hot-pressing mold with a certain amount of wood mixed with methylene diphenyl diisocyanate (MDI) glue. Sustainable wood strips, various bottom boards that may be fastened to the bottom of the pallet, or double-sided pallets to create a range of pallet constructions.

### BACKGROUND OF THE INVENTION

Pallets serve as a transporter of products and an important instrument for freight transportation. Pallets were used more than 7 billion times throughout the world in 2019. The majority of these pallets are constructed of wood, although a handful are made of plastic or other materials. Wooden pallets are made by chopping down trees, which destroys the natural ecosystem, whereas plastic pallets include chemicals such as plasticizers, which are harmful to the environment and human health.

This innovation differs from existing pallet materials on the market. It makes use of reclaimed wood while also processing leftover wood, sawdust, straw, and other materials. The basic ingredients are combined with a specialized methylene diphenyl diisocyanate (MDI) component glue. The many support legs and innovative groove construction improve the load-bearing and anti-slip properties, resulting in a Net Zero Green Energy Mdi pallet. The bottom support legs can be customized with green energy wooden strips, 2×2 grid bottom boards, green energy bottom boards, or double-sided pallets to eliminate the problem of the conveyor belt being stuck.

To tackle the issue of global warming and climate change, governments throughout the world will limit forest cutting by 2030 and enact the “Global Plastics Treaty” in 2024 to minimize plastic packaging, among other things. Taiwan outlawed logging in natural forests in 1991. Plastic restriction restrictions have been steadily implemented since 2002. On third reading in 2023, the Legislative Yuan enacted an amendment to the “Climate Change Response Act”. In the future, a “carbon fee” will be imposed in phases to reach the objective of Net Zero Emissions by 2050.

This invention of “MDI included Net Zero Green Energy Pallet Composition” would make the pallet material conform with the worldwide environmental consensus while avoiding the harm caused by felling trees, plasticizers, and other chemicals. It will contribute to mitigating the global warming catastrophe. Currently, European and American governments have targeted imported items by implementing a “carbon tax” scheme. This idea will assist businesses in reducing carbon emissions and carbon costs, improving corporate ESG indicators, and developing a new product that blends environmental protection and economic viability.

### SUMMARY OF THE INVENTION

This invention provides a “MDI included Net Zero Green Energy Pallet Composition”. In one embodiment, the invention of “MDI included Net Zero Green Energy Pallet” is made of recycled wood, processing residual wood, sawdust, straw, etc., crushing and drying by machines. The wood chips are mixed with methylene diphenyl diisocyanate (MDI) component glue, and then hot-pressed with a mold at high temperature. The appearance of the pallet is mainly in the 2×2 grid. The four corners are designed with arcs to avoid damage to the goods. Various sizes can be developed according to the hot-pressing mold.

In one perspective, the “MDI included Net Zero Green Energy Pallet Composition” structure consists of a pallet body and nine support legs. The surface of the nine support legs is trapezoidal in shape, while the inside has concave downward left support legs, center support legs, and right support legs. It has left operating room for the forklift in four directions: front, rear, left and right. The nine support legs' inside recessed shape makes it easier to stack pallets and saves storage space for empty ones.

Furthermore, this invention of “MDI included Net Zero Green Energy Pallet Composition” in which the “MDI included Net Zero Green Energy Pallet” is composed of reinforcing ribs structure, including connecting reinforcing ribs, arc-shaped reinforcing ribs, central connecting reinforcing ribs, and central reinforcing ribs. Reinforcing ribs are groove structures molded onto the pallet's surface that improve the pallet's strength, load-bearing capacity, and anti-slip properties. The reinforcing ribs in this design of “MDI included Net Zero Green Energy Pallet” offer a higher load-bearing capacity and anti-slip capability than ordinary pallets.

In one embodiment, this innovation of “MDI included Net Zero Green Energy Pallet Composition” adds conveyor belt components with green energy wooden strips to the “MDI included Net Zero Green Energy Pallet” bottom. The green energy wooden strips are composed of wood and methylene diphenyl diisocyanate (MDI) component adhesive. The green energy wooden strips are nailed or screwed into the various support legs, which may be positioned vertically or horizontally. This permits the pallet to be carried by manufacturing conveyor belt.

In one exemplification, this invention of “MDI included Net Zero Green Energy Pallet Composition”, in which the “MDI included Net Zero Green Energy Pallet” bottom is added the conveyor belt components with 2×2 grid bottom board. The 2×2 grid bottom board is made of one piece of wood and cemented using methylene diphenyl diisocyanate (MDI). The 2×2 grid bottom board features several support legs that are hammered or secured in place. This permits pallets to be transported on plant conveyor belts and strengthens them.

In one regard, this innovation of “MDI included Net Zero Green Energy Pallet Composition” in which the “MDI included Net Zero Green Energy Pallet” bottom is added conveyor belt components with green energy bottom board. The green energy bottom board is made of wood and bonded with methylene diphenyl diisocyanate (MDI) component adhesive. Several support legs are hammered or screwed into the green energy bottom board. This permits pallets to be transported on the manufacturing conveyor belt and safely stored on the warehouse rack.

This innovative “MDI included Net Zero Green Energy Pallet Composition” has one embodiment in which the “MDI included Net Zero Green Energy Pallet” is integrated inside an ultra-thin pallet. The ultra-thin pallet is made of wood and methylene diphenyl diisocyanate (MDI) component glue, with a one-piece mold. The support legs are hot-press molded into 16 circular shapes with concave downward interiors. The conveyor belt's components are nailed or connected to the 16 support legs. This permits pallets to be transported down the production conveyor belt while maintaining an incredibly low pallet height.

In one sense, this innovation of “MDI included Net Zero Green Energy Pallet Composition” converts the “MDI included Net Zero Green Energy Pallet” into a double-sided pallet. A double-sided pallet is combined with two pallets. Each pallet is made of wood and bonded using methylene diphenyl diisocyanate (MDI) components. It features sixteen spherical support legs. The two pallets are stacked back-to-back and fastened with nails or screws. This enables pallets to be transported on an industrial conveyor belt while also boosting pallet stability.

### BRIEF DESCRIPTION OF DRAWINGS

FIG. 1 is a structural view of this invention of “MDI included Net Zero Green Energy Pallet Composition”.

FIG. 2 is a side structural view of this invention of “MDI included Net Zero Green Energy Pallet Composition”.

FIG. 3 is a reinforcing rib structural view of this invention of “MDI included Net Zero Green Energy Pallet Composition”.

FIG. 4 is a green energy wooden strips combination view of this invention of “MDI included Net Zero Green Energy Pallet Composition”.

FIG. 5 is a 2×2 grid bottom board combination view of this invention of “MDI included Net Zero Green Energy Pallet Composition”.

FIG. 6 is a green energy bottom board combination view of this invention of “MDI included Net Zero Green Energy Pallet Composition”.

FIG. 7 is a ultra-thin pallet view of this invention of “MDI included Net Zero Green Energy Pallet Composition”.

FIG. 8 is a double-sided pallet view of this invention of “MDI included Net Zero Green Energy Pallet Composition”.

### DETAILED DESCRIPTION OF THE INVENTION

This invention provides a reference in one preferred embodiment: this invention of “MDI included Net Zero Green Energy Pallet Composition”, in which the “MDI included Net Zero Green Energy Pallet” production process adopts recycled wood, processing residual wood, sawdust, straw, and so on as raw materials. First, raw materials are crushed by machinery to produce wood with a length of less than 3 cm. The wood is next dried to a moisture level of around 4-5%. The wood is combined with MDI component glue, which is then put to the glue mixing machine. The ratio is around 94-95% wood and 5-6% MDI component glue. Add a tiny quantity of distilled water, mix evenly, and then spread it out on the hot-pressing mold. The hot pressing temperature ranges from 130 to 150° C., with a period of 120 to 150 seconds and a pressure of 500 to 600 tons per square centimeter. After the hot pressing is complete, remove the pallet and scrape the whole side corners.

MDI is a broad term for a group of chemical compounds. English is Methylene Diphenyl Diisocyanate, often known as MDI, which comprises pure MDI, polymerized MDI, and modified MDI. The above-mentioned methylene diisocyanate Phenyl diisocyanate (MDI) component glue is made of MDI and other modifiers, which is a modified MDI. Specifically, crude MDI may be distilled to obtain pure MDI and polymerized MDI. Pure MDI may produce MDI isomers in a certain proportion, such as 4,4′-MDI, 2,4′-MDI, 2,2′-MDI, and others. To create methylene diphenyl diisocyanate (MDI) component glue, combine and alter MDI isomers with modifiers such polyvinyl alcohol or triethanolamine at a mass ratio of 0.01-10:100. Formaldehyde is not included in this methylene diphenyl diisocyanate (MDI) component adhesive, sometimes known as “MDI glue”. When mixed with wood, it offers a higher load-bearing capacity and a lower water absorption expansion rate than conventional glues.

This invention of “MDI included Net Zero Green Energy Pallet Composition”, the appearance is mainly 2×2 grid. Its four corners are designed with arcs to reduce the wear and damage of the pallets on surrounding objects. It can be developed according to the hot-pressing mold to comply with 110 cm×110 cm in Asia, 120 cm×100 cm in North America, 120 cm×80 cm in Europe, and other sizes required by the world, or special sizes such as 100 cm×100 cm, 105 cm×105 cm, etc. The height of the pallet can also be adjusted according to individual needs.

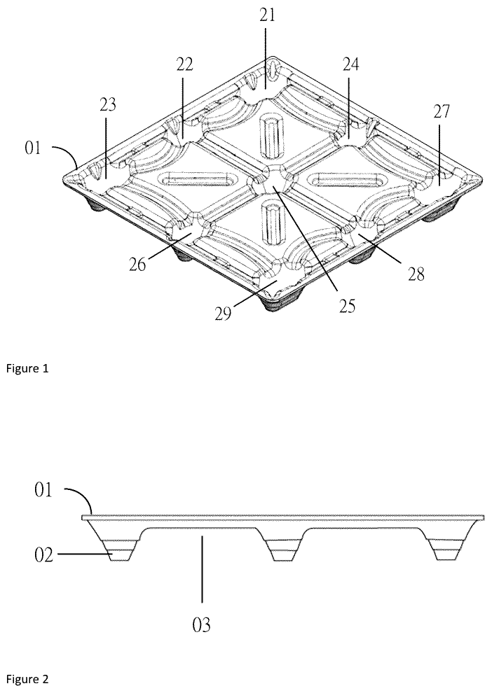

As Shown in FIG. 1 is a structure of this invention of “MDI included Net Zero Green Energy Pallet Composition”, in which the “MDI included Net Zero Green Energy Pallet” includes a pallet body 01, and the nine support legs include concave downward left support leg 21, left support leg 22, left support leg 23, center support leg 24, center support leg 25, center support leg 26, right support leg 27, right support leg 28, right support leg 29, that support the center and corners of the pallet to make the pallet stable.

FIG. 2 depicts a side structure of the invention “MDI included Net Zero Green Energy Pallet Composition”. The nine support legs outside 02 use a trapezoidal shape to hold the pallet body 01, allowing a working space 03 for the forklift. The forklift's front legs may be moved in four directions: front, rear, left, and right, to aid in logistical activities.

The “MDI included Net Zero Green Energy Pallet Composition” concept has nine support legs that are hot-pressed into an outside trapezoidal form and an inside concave design. Pallet support legs can be placed in the depressions to stack empty pallets, conserving storage space. If regular wooden pallets are stacked about 20, this invention of “MDI included Net Zero Green Energy Pallet” may be stacked around 60, saving nearly three times as much storage space as typical pallets.

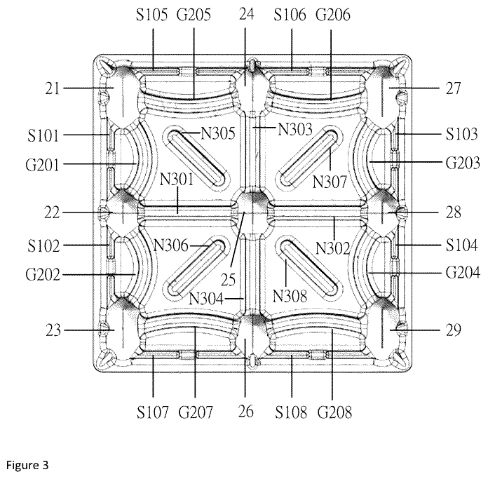

FIG. 3 depicts a reinforcing rib structure of this invention's “MDI included Net Zero Green Energy Pallet Composition”. Reinforcing ribs are groove structures molded onto the pallet's surface that can increase the pallet's strength and load-bearing capability while also strengthening the pallet's anti-slip function when transporting items.

The reinforcing ribs of this invention contain connecting reinforcing rib S101 and arc-shaped reinforcing rib G201, which link the left support legs 21 and 22.

The connecting reinforcing rib S102, arc-shaped reinforcing rib G202, which connect the left support leg 22 and left support leg 23.

The connecting reinforcing rib S103, arc-shaped reinforcing rib G203, which connect the right support leg 27 and right support leg 28.

The connecting reinforcing rib S104, arc-shaped reinforcing rib G204, which connect the right support leg 28 and right support leg 29.

The connecting reinforcing rib S105, arc-shaped reinforcing rib G205, which connects the left support leg 21 and center support leg 24.

The connecting reinforcing rib S106, arc-shaped reinforcing rib G206, which connects the center support leg 24 and right support leg 27.

The connecting reinforcing rib S107, arc-shaped reinforcement rib G207, which connects the left support leg 23 and center support leg 26.

The connecting reinforcing rib S108, arc-shaped reinforcing rib G208, which connects the center support leg 26 and right support leg 29.

The central connecting reinforcing rib N301, which connects the left support leg 22 and center support leg 25.

The central connecting reinforcing rib N302, which connects the center support leg 25 and right support leg 28.

The central connecting reinforcing rib N303, which connects the center support leg 24 and center support leg 25.

The central connecting reinforcing rib N304, which connects the center support leg 25 and center support leg 26.

The central reinforcing rib N305 is located at the upper left of the pallet. The central reinforcing rib N306 is located at the lower left of the pallet. The central reinforcing rib N307 is located at the upper right of the pallet. The central reinforcing rib N308 is located at the lower right of the pallet.

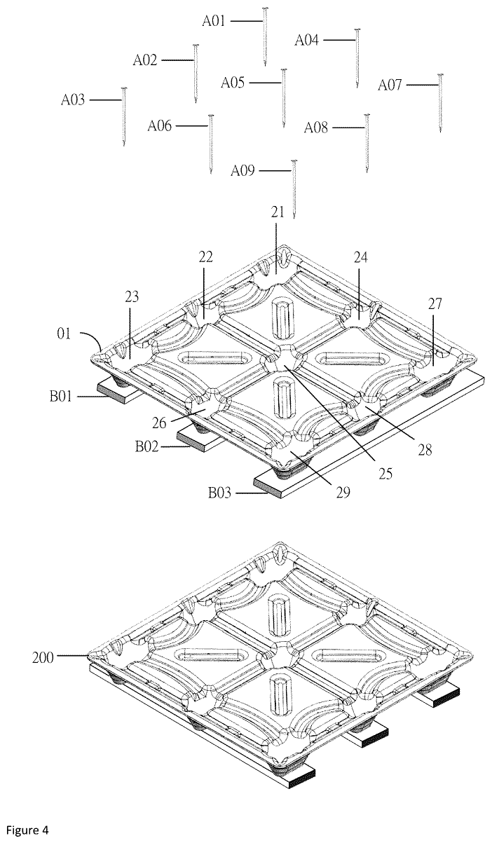

FIG. 4 depicts a preferred embodiment of the invention “MDI included Net Zero Green Energy Pallet Composition”. The bottom of “MDI included Net Zero Green Energy Pallet Composition” is attached to conveyor belt components, which are green energy wooden strips. Green energy wooden strips are constructed from wood and glued using methylene diphenyl diisocyanate (MDI). Green energy wooden strips B01-B03 are nailed or screwed onto the pallet body 01, and the nine support legs 21-29 allow the pallet to be carried on the manufacturing conveyor belt. It specifically comprises iron nail A01, which is used to connect the left support leg 21 and green energy wooden strip B01. The iron nail A02 is used to connect the left support leg.

The iron nail A03 is nailed to combine the left support leg 23 and green energy wooden strip B01. The iron nail A04 is nailed to combine the central support leg 24 and green energy wooden strip B02. The iron nail A05 is nailed to combine the center support leg 25 and green energy wooden strip B02. The iron nail A06 is nailed to combine the center support leg 26 and green energy wooden strip B02. The iron nail A07 is nailed to combine the right support leg 27 and green energy wooden strip B03. The iron nail A08 is nailed to combine the right support leg 28 and green energy wooden strip B03. The iron nail A09 is nailed to combine the right support leg 29 and green energy wooden strip B03. Furthermore, the green energy wooden strips can adopt the horizontal strip mode 200, and each support leg is also nailed or screwed to join the nine support legs.

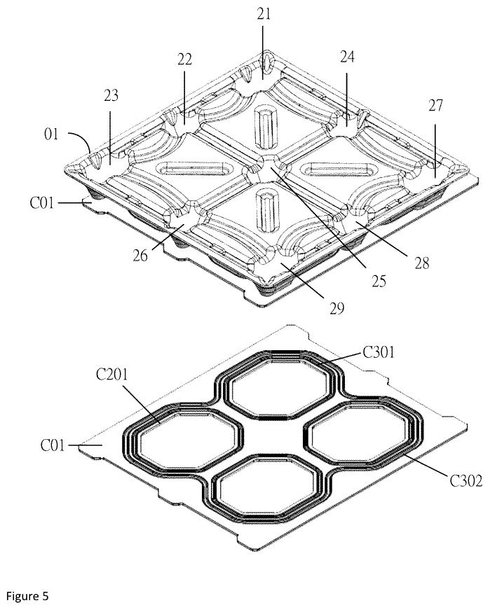

FIG. 5 depicts a preferred embodiment of the invention “MDI included Net Zero Green Energy Pallet Composition”. The bottom of “MDI included Net Zero Green Energy Pallet” has a conveyor belt component that is a 2×2 grid bottom board. The 2×2 grid bottom board is a single-piece bottom board constructed of wood and glued using methylene diphenyl diisocyanate (MDI). It has a 2×2 grid bottom board C01, 4 octagonal cavities C201, 4 octagonal reinforcing ribs C301, and many peripheral reinforcing ribs C302. The 9 support legs 21-29 are nailed or fastened to unite with the 2×2 grid bottom board C01. This allows the pallet to be moved on the manufacturing conveyor belt and is sturdier. Hollowing out four octagon shapes reduces the quantity of wood material used and the weight of the bottom board. The reinforcing ribs may strengthen the bottom board and improve the pallet's anti-slip performance.

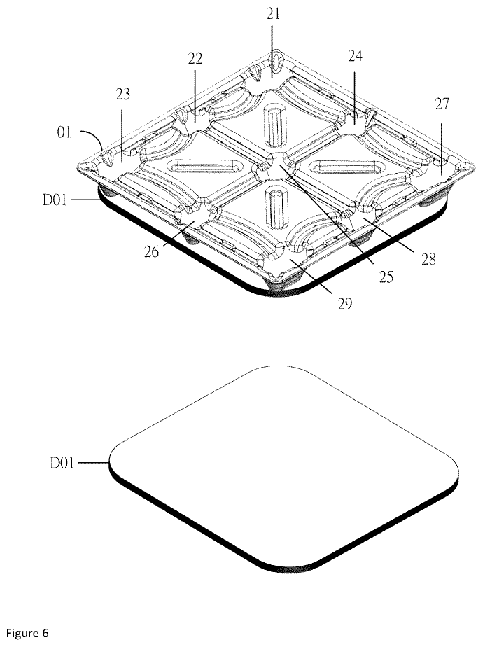

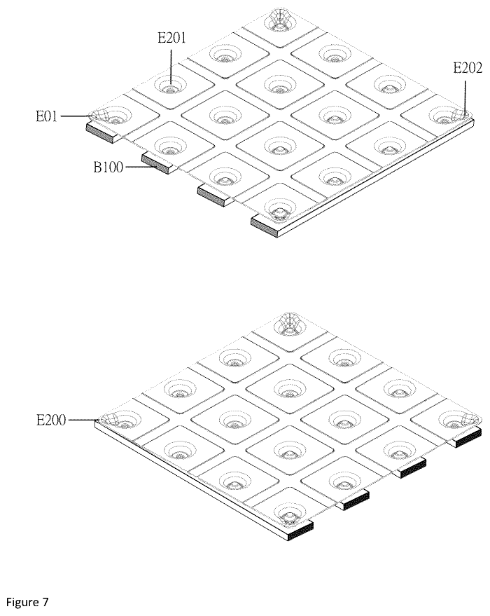

FIG. 6 depicts a preferred embodiment of the invention “MDI included Net Zero Green Energy Pallet Composition”. The bottom of “MDI included Net Zero Green Energy Pallet” has a conveyor belt component that is a green energy bottom board. The green energy bottom board is constructed of wood glued using methylene diphenyl diisocyanate (MDI) component adhesive. It is constructed with rounded edges. It contains the green energy bottom board D01. The nine support legs 21-29 are nailed or screwed to the green energy bottom board D01, allowing the pallet to be carried on the production conveyor belt and positioned on the warehouse rack.

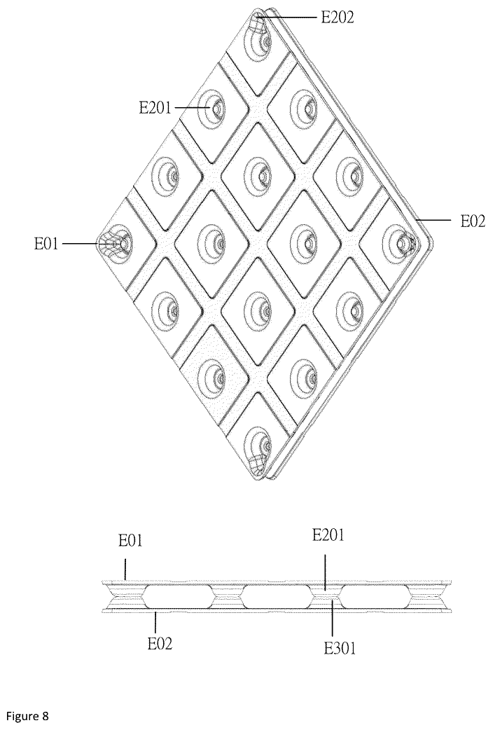

FIG. 7 depicts a preferred embodiment of the invention “MDI included Net Zero Green Energy Pallet Composition”. It is an ultra-thin pallet type constructed of wood and methylene diphenyl diisocyanate (MDI) component adhesive that is molded in a single piece. The support legs are hot-pressed into 16 circular forms with a concave downward interior. The green energy wooden strips are nailed or screwed to the 16 support legs, allowing the pallets to be carried on conveyor belts while maintaining an ultra-low pallet height. It contains; 16 round support legs pallet body E01, 16 round support legs E201, and pallet reinforcing ribs E202 on all four corners, which may improve the load-bearing and anti-slip properties of the pallet. The four green energy wooden strips B100 are nailed or fastened together to form the 16 round support legs pallet body E01 and 16 round support legs E201. Furthermore, the green energy wooden strips can use the horizontal strip mode E200, and each support leg is nailed or screwed together to form 16 support legs.

FIG. 8 depicts a preferred embodiment of the invention “MDI included Net Zero Green Energy Pallet Composition”. This is the double-sided pallet style. The double-sided pallet is constructed by combining two pallets. Each pallet is constructed of wood glued using methylene diphenyl diisocyanate (MDI) component glue. The support legs are hot-pressed into 16 circular forms with a concave downward interior. The top and lower pallets are stacked back-to-back and secured with nails or screws, allowing the pallets to be carried on the conveyor belt while also increasing pallet stability.

It contains the 16 round support legs pallet body E01 at the top, 16 round support legs E201 at the top, 16 round support legs pallet body E02 at the bottom, 16 round support legs E301 at the bottom, and pallet reinforcing ribs E202. The 16 round support legs E201 at the top are nailed or fastened to the 16 round support legs E301 at the base. The pallet reinforcing ribs E202 are located at four corners, which improves the pallet's load bearing and anti-slip properties. The double-sided pallet design increases the pallet's stability.

This invention's preferred embodiments are described above. Pallets made of wood combined with methylene diphenyl diisocyanate (MDI) component glue, hot-pressed by a machine, combined with nine support legs, 16 round support legs, reinforcing ribs, conveyor belt components, ultra-thin pallets, and double-sided pallets, etc., should all be considered within the patent scope of this invention.

1. the “MDI included Net Zero Green Energy Pallet Composition” has a 2×2 grid appearance and consists of a pallet body, multiple support legs, reinforcing ribs, conveyor belt components, or double-sided pallet type;
the upper and lower connection relationships are configured as follows:
the pallet body, reinforcing ribs, and multiple support legs are molded by hot pressing;
conveyor belt components are made of green energy wooden strips, 2×2 grid bottom board, or green energy bottom board, combined with methylene diphenyl diisocyanate (MDI) component glue;
conveyor belt components are nailed or screwed in vertical or horizontal directions to combine with multiple support legs.

2. The “MDI included Net Zero Green Energy Pallet Composition” of claim 1, wherein the “MDI included Net Zero Green Energy Pallet” production process:
using recycled wood, processing residual wood, sawdust, and straw as raw materials;
using machinery to crush the wood until the length of the wood is less than 3 cm;
drying the wood to a moisture content of 4 to 5%;
adding the wood and methylene diphenyl diisocyanate (MDI) component glue to the glue mixing machine;
the proportion using the hot pressing temperature of 130-150° C., the duration is 120-150 seconds, and with hot pressing pressure of 500˜600 t/m².

3. The “MDI included Net Zero Green Energy Pallet Composition” of claim 2 includes a methylene diphenyl diisocyanate (MDI) component glue made of MDI and polyvinyl alcohol or triethanolamine, with modifier: MDI=0.01˜10:100 mass ratio or mixed and modified in any proportion.

4. The “MDI included Net Zero Green Energy Pallet Composition” of claim 1 with nine support legs is a nine support legs type;
pallet support legs are hot-pressed into trapezoidal shapes with concave interiors;
they can be embedded in depressions for stacking;
reinforcing ribs are molded into grooves on the pallet surface and include connecting reinforcing ribs, arc-shaped reinforcing ribs, central connecting reinforcing ribs and central reinforcing ribs.

5. The “MDI included Net Zero Green Energy Pallet Composition” of claim 1 includes 16 support legs and an ultra-thin pallet;
the support legs are hot-pressed into a round shape with a concave downward inside;
the reinforcing ribs are hot-pressed at the four corners of the pallet;
the pallet below is nailed or screwed to connect the conveyor belt components.

6. The “MDI included Net Zero Green Energy Pallet Composition” of claim 1 includes 16 support legs and a double-sided pallet;
the support legs are hot-pressed into a round shape with a concave downward inside;
the reinforcing ribs are hot-pressed at the four corners of the pallet;
the upper and lower pallets are placed back to back and connected with nails or screws.

7. The “MDI included Net Zero Green Energy Pallet Composition” of claim 1 has four corners constructed with arcs, allowing the forklift to work on the front, back, left, and right.

8. The “MDI included Net Zero Green Energy Pallet Composition” of claim 1 wherein the conveyor belt component of 2×2 grid bottom board is a one-piece bottom board, containing the bottom board body, four octagonal cavities, four octagonal reinforcing ribs, and numerous peripheral reinforcing ribs.
